(19) United States
(12) Patent Application Publication
(10) Pub. No.: US 2025/0305819 A1
(43) Pub. Date: Oct. 2, 2025

(54) THREE-DIMENSIONAL DATA MEASURING SYSTEM USING A MEASUREMENT MODULE

(71) Applicant: TOPCON CORPORATION, Tokyo (JP)

(72) Inventors: Homare MOMIYAMA, Tokyo (JP); You SASAKI, Tokyo (JP)

(73) Assignee: TOPCON CORPORATION, Tokyo (JP)

(21) Appl. No.: 19/078,558

(22) Filed: Mar. 13, 2025

(30) Foreign Application Priority Data
Mar. 29, 2024 (JP) 2024-057771

(51) Int. Cl. G01C 3/08; G01B 11/02

(52) U.S. Cl. CPC G01C 3/08; G01B 11/026

(57) ABSTRACT

Provided is a three-dimensional data measuring system including a measuring module including a prism, an electronic distance meter configured to measure an irradiated point, an inertial measurement unit detecting posture information, a notification unit, a communication unit, and a control arithmetic unit configured to calculate own position coordinates and the irradiated point position coordinates, and a surveying instrument configured to acquire the prism position coordinates, and transmit the prism position coordinates to the communication unit. The control arithmetic unit is configured to partition the measurement range into mesh-like partitioned areas and acquire three-dimensional data for each partitioned area, and determine whether a partitioned area satisfies at least one condition for each time acquiring a measurement value, and, when the partitioned area satisfies the condition, instruct the notification unit to issue a warning and re-partition a condition-satisfying area into a plurality of areas with dimensions smaller than initial dimensions.

### TECHNICAL FIELD

The disclosure relates to three-dimensional data measuring systems, and more particularly, to a three-dimensional data measuring module and a three-dimensional data measuring system using a measurement module and a surveying instrument.

### BACKGROUND

Three-dimensional data measuring systems have been conventionally used for “current surface measurement” or “site surface survey”, which refers to the process of measuring the current condition of a surface, such as land, buildings, or structures. The current surface measurement is commonly used in construction work to assess terrain elevation and surface irregularities. Such measuring systems, including a total station having an auto-tracking function and a pole with a prism has been used in conventional current surface measurement in construction work, allows an operator to measure a measurement point by just placing the pole on the point while the total station automatically tracks the prism to measure the position coordinates of the prism. During the measurement, the operator is required to place the prism horizontally by observing a bubble-level device attached with the prism or the pole. Thus, longer working hours leads to a great burden on the operator. Besides, such a system requires the operator to know a length of the pole in advance and input the value thereof to the system.

Patent literature 1 has disclosed a three-dimensional data measuring system comprising a GNSS receiver, a tilt sensor, an azimuth sensor, and an electronic distance meter to measure a three-dimensional position of an irradiated point of the electronic distance meter without using the pole.

### CITATION LIST

### Patent Literature

Patent Literature 1: JP 2007/248156 A1

### SUMMARY

### Technical Problem

The three-dimensional data measuring system of patent literature 1 enables the measurement without a pole but does not allow the measurement in indoor environments due to poor satellite-signal reception. In addition, even in outdoor environments with strong satellite-signal reception, the timing of measurement, which affects the number of available satellites or the geometric location of satellites, may deteriorate the accuracy of the measurement. Furthermore, a demand exists for more accurate measurement without the needs for the pole.

The disclosure has been made in view of the above circumstances, and an object thereof is to provide a three-dimensional data measuring system capable of measuring three-dimensional data more accurately without using a pole for a prism.

### Solution to Problem

To achieve the above object, a first aspect of the present disclosure has a configuration of a three-dimensional data measuring system comprising: a measuring module including a prism retroreflecting incident light, an electronic distance meter configured to transmit distance-measuring light to a measurement range, receive a reflected distance-measuring light reflected from an irradiated point of the distance-measuring light, to detect a distance to the irradiated point, an inertial measurement unit detecting posture information, a notification unit configured to issue a warning, a communication unit configured to receive prism position coordinates, and a control arithmetic unit configured to calculate position coordinates of the measuring module based on the prism position coordinates and the posture information, and calculate irradiated point position coordinates based on the position coordinates of the measuring module, the distance to the irradiated point, and the posture information; and a surveying instrument configured to measure a distance to and angle of the prism to acquire the prism position coordinates, and transmit the prism position coordinates to the communication unit, the system configured to acquire three-dimensional data of the measurement range. The control arithmetic unit is configured to partition the measurement range into mesh-like partitioned areas and acquire three-dimensional data for each partitioned area, and determine whether the partitioned area satisfies at least one condition each time acquiring the measurement value of a partitioned area, and, when the partitioned area satisfies the condition, instruct the notification unit to issue a warning and re-partition a condition-satisfying area that satisfies the condition into a plurality of areas with dimensions smaller than initial dimensions.

The second aspect is, in the first aspect, the at least one condition includes that partitioned areas adjacent to each other have a difference in the three-dimensional data outside a threshold range.

The third aspect is, in the first or second aspect, the at least one condition includes that the condition includes that the electronic distance meter receives the reflected measuring light at a light reception amount outside a threshold range.

The fourth aspect is, in any one of the first to third aspect, the condition includes that the condition includes that the partitioned area have the three-dimensional data outside a threshold range.

The fifth aspect, in any one of the fourth aspect, further includes a display unit configured to display a measurement screen indicating a measurement status of the measurement range, wherein the display unit displays a measurement progress for each partitioned area in a manner allowing real-time identification, the measurement screen displays the partitioned areas that has been measured in colors that vary depending on a measurement result for the partitioned areas, and after re-partitioning the condition-satisfying areas, the control arithmetic unit resets the measurement value of the condition satisfying area, so that the display unit displays the condition-satisfying area in a color that the re-partitioned condition-satisfying areas are unmeasured.

### BRIEF DESCRIPTION OF DRAWINGS

Various aspects and embodiments of the application will be described with reference to the following figures. Items appearing in multiple figures are indicated by the same or a similar reference number in all the figures in which they appear.

FIG. 1 illustrates an outline of a three-dimensional data measuring system according to an embodiment of the present invention.

FIG. 2 is a configuration block diagram of the three-dimensional data measuring system.

FIG. 3A illustrates a measurement range setting in measurement region data used in the three-dimensional data measuring system. FIG. 3B illustrates mesh-like partitions set in the measurement range.

FIGS. 4A to 4C illustrate partitioning of the measurement area and re-partitioning of a part thereof.

FIGS. 5A to 5C illustrate examples of the partitioning of the measurement area and the re-partitioning of a part thereof. FIGS. 5A to 5C illustrate measurement screens displayed on a display unit during measurement.

FIGS. 6A to 6C illustrate examples of the partitioning of the measurement area and the re-partitioning of a part thereof. FIGS. 6A to 6C illustrate a measurement screen displayed on a display unit during measurement.

FIG. 7 is a flowchart of a pre-process for three-dimensional data measuring using the three-dimensional data measuring system.

FIG. 8 is a flowchart of a main process for the three-dimensional data measuring using the three-dimensional data measuring system.

### ADVANTAGES OF INVENTION

According to the above aspects, it is possible to provide a three-dimensional data measuring system capable of accurately measuring three-dimensional data without a prism pole.

### DESCRIPTION OF EMBODIMENTS

Hereinafter, preferred embodiments of the present invention will be described with reference to the drawings, but the present invention is not limited thereto. In each embodiment, the same constituents are denoted by the same reference signs, and redundant description will be omitted.

### 1. Overall Configuration

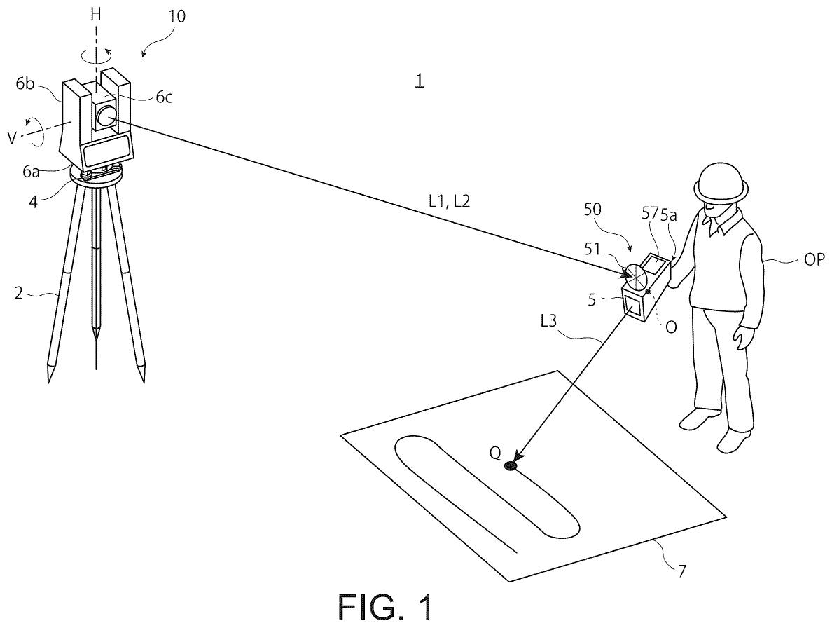

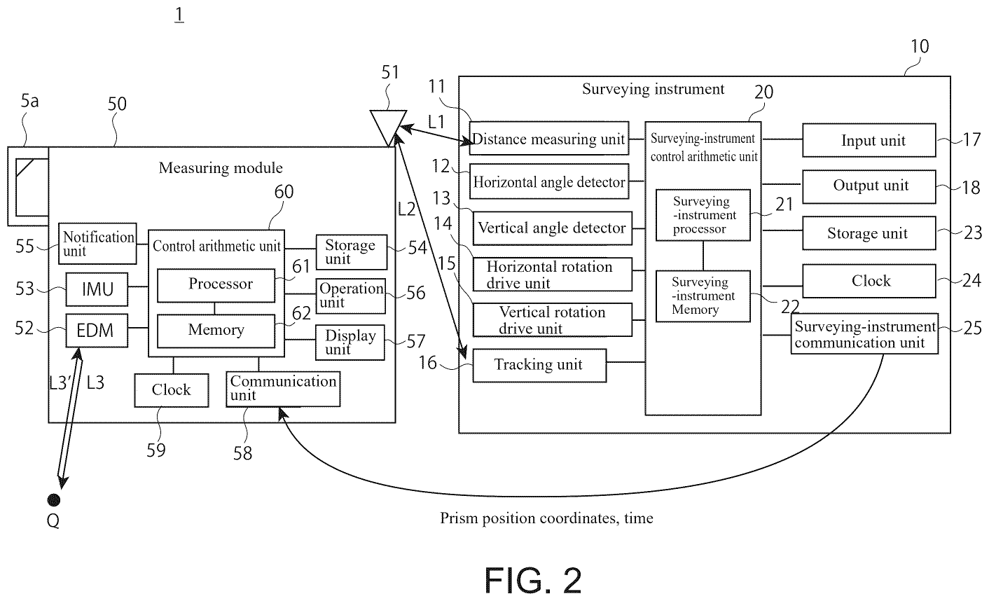

FIG. 1 illustrates a schematic configuration of a three-dimensional data measuring system 1 (hereinafter, simply referred to as system 1). The system 1 is preferably configured for current surface measurements at a construction site. FIG. 2 illustrates a configuration block diagram of the system 1. The system 1 generally includes a surveying instrument 10 and a measuring module 50.

In the illustrated example, the surveying instrument 10 is a motor-drive total station with an auto-tracking function. The surveying instrument 10, installed at a known point, is used with the coordinates and the direction angle that are already known. Note that, in this detailed description, the expression “install a surveying instrument at a known point” represents not only installing the surveying instrument at the known point but also installing the surveying instrument at an arbitrary point that can be determined the coordinates by using a backward intersection or other methods.

As illustrated in FIG. 1, the surveying instrument 10 includes, a base portion 6a, a bracket portion 6b configured to rotate horizontally about an H axis with respect to the base portion 6a, and a telescope 6c configured to rotate vertically about a V axis at the center of the bracket portion 6b. The base portion 6a is mounted on a leveling stand 4, which is attached to a tripod 2.

The measuring module 50 includes a substantially rectangular parallelepiped housing 5 in the hand-held size. The housing 5 is provided with a prism 51, which will be described later, fixed to the front side of an upper surface. The housing 5 also has a display unit 57, which will be described later, on the rear side of the upper surface. This configuration allows an operator OP to irradiate distance-measuring light L3 for a measurement object while watching the display unit 57.

The measuring module 50 is a so-called handheld module. The housing 5 includes a grip 5a, which allows an operator OP to grip the measuring module 50 with one hand to measure. The measuring module 50 is configured emit the distance-measuring light L3 from a front surface of the housing 5. Providing a switch to start the measurement in the grip 5a in a trigger mechanism is preferable because the switch allows the operator to intuitively recognize a direction of the measurement, resulting in easier measurement.

### 2. Surveying Instrument 10

As illustrated in FIG. 2, the surveying instrument 10 includes a distance-measuring unit 11, a horizontal angle detector 12, a vertical angle detector 13, a horizontal rotation drive unit 14, a vertical rotation drive unit 15, a tracking unit 16, an input unit 17, an output unit 18, a surveying-instrument control arithmetic unit 20, a storage unit 23, a surveying instrument clock 24, and a surveying-instrument communication unit 25.

The distance measuring unit 11 comprises a light transmitting unit, which includes a light emitting element such as a laser diode, that emits laser light L1 (e.g., infrared laser light) as distance-measuring light. The distance measuring unit 11 also comprises a distance measuring optical system and a light receiving unit, which include a light receiving element such as an avalanche photodiode. The light emitting element, the distance measuring optical system, and the light receiving unit are not illustrated in FIG. 2. The distance measuring unit 11, housed in the telescope 6c, has an optical axis of the distance-measuring light that coincides with a collimation optical axis of the telescope 6c. The distance-measuring unit 11 emits the distance-measuring light, such as infrared laser light, to the prism 51 (described later) via the distance-measuring optical system and receives reflected light with the light receiving unit to measure a distance to the center of the prism 51 based on the phase difference or the time difference between the distance-measuring light and the internal reference light.

The horizontal angle detector 12 and the vertical angle detector 13 are each implemented using absolute encoders or incremental encoders. The horizontal angle detector 12 detects a horizontal angle of the base portion 6a, that is, a horizontal angle of the collimation axis of the telescope 6c. The vertical angle detector 13 detects a vertical angle of the collimation axis of the telescope 6c.

The horizontal rotation drive unit 14 and the vertical rotation drive unit 15 are each implemented using motors. The surveying-instrument control arithmetic unit 20 controls the horizontal rotation drive unit 14 and the vertical rotation drive unit 15. The horizontal rotation drive unit 14 drives a rotation shaft, provided on the base portion 6a, to horizontally rotate the bracket portion 6b. The vertical rotation drive unit 15 drives a rotation shaft, which supports the telescope 6c rotatably with respect to the bracket portion 6b, to vertically rotate the telescope 6c. Both of the drive units cooperatively rotate the telescope 6c in the horizontal and vertical direction.

The tracking unit 16 includes a tracking light transmitting unit, which includes a light emitting element such as a laser diode; a tracking optical system; and a tracking light receiving unit, which includes an image element such as a charge-coupled device (CCD) or a complementary metal-oxide-semiconductor (CMOS). The light transmitting unit, the tracking optical system, and the tracking light receiving unit are not illustrated in FIG. 2. The tracking unit 16 emits infrared laser light as tracking light L2, which has a wavelength different from that of the laser light L1. The tracking unit 16 captures landscape images in a direction of the collimation axis when the tracking light L2 is on and when it is off. The tracking unit 16 provides the both images to the surveying instrument-control arithmetic unit 20. The surveying-instrument control arithmetic unit 20 determines the center position of an image of the prism 51, which serves as the surveying target, by using the difference between the two images and calculating the position of the prism 51. Based on the determined position of the prism 51, the surveying instrument-control arithmetic unit 20 instructs the horizontal rotation drive unit 14 and the vertical rotation drive unit 15 to maintain the distance between the center of the prism 51 and the collimation axis of the telescope 6c within a certain range. This allows the telescope 6c to always point toward the prism 51.

The input unit 17 is an input device that comprises an input mechanism, such as buttons and keys, to receive inputs an operator, such s commands or configuration settings, for measurement tasks and output them to the surveying-instrument control arithmetic unit 20. The output unit 18 is a device that serves as a display for an operator, such as a liquid crystal display. The output unit 18 displays screens, such as a measurement condition setting screen and a measurement result check screen, under the control of the surveying-instrument control arithmetic unit 20. The input unit 17 and the output unit 18 may be integrated into a touch panel display.

The storage unit 23 is implemented using computer-readable storage media, such as hard disc drives (HDDs) or flash memory. The storage unit 23 stores programs for the surveying instrument 10 to execute various functions, such as a surveying function and an auto-tracking function. The storage unit 23 also stores various types of data, such as measurement data acquired by the surveying instrument 10.

The surveying instrument clock 24 is a device that keeps time and may be implemented using a system clock or a hardware clock. The surveying instrument clock 24 assigns timestamps to a piece of transmitted data to synchronize a measurement timing with the measuring module 50.

The surveying-instrument communication unit 25 is a communication interface that facilitates information exchange between the surveying instrument 10 and the measuring module 50. Examples of communication means include Wi-Fi, Bluetooth (a registered trademark), and infrared communication. The communication means is not limited thereto and may be implemented using other methods compliant to known wired and wireless communication standards. The surveying instrument 10 assigns timestamps to measurement result data from the prism measurement, which includes the position coordinates of the prism, and transmits the measurement result data to the measuring module 50 via the surveying-instrument communication unit 25.

The surveying-instrument control arithmetic unit 20 is a control arithmetic unit that comprises a surveying-instrument processor 21 and a surveying-instrument memory 22. The surveying-instrument processor 21 includes at least one processor, such as a central processing unit (CPU). The surveying instrument memory 22 includes at least one memory such as a static random-access memory (SRAM) or a dynamic random-access memory (DRAM). When the surveying-instrument processor 21 carries out functions of the surveying instrument 10 in a software manner, the surveying-instrument control arithmetic unit 20 reads programs for implementing functions into the memory 22 and executes the programs to carry out the function.

In addition, at least a part of the surveying-instrument processor 21 may be configured with a hardware such as a complex programmable logic device (CPLD), or a field programmable gate array (FPGA).

The surveying-instrument control arithmetic unit 20 controls the tracking unit 16, the horizontal rotation drive unit 14, and the vertical rotation drive unit 15 so that the surveying instrument 10 automatically tracks the prism 51. The surveying-instrument control arithmetic unit 20 controls the distance-measuring unit 11, the horizontal angle detector 12, and the vertical angle detector 13 so that the surveying instrument 10 measures the distance and angle of the prism 51 at a predetermined timing. Based on the results of the distance and angle measurement of the prism 51, the surveying-instrument control arithmetic unit 20 calculates the center position coordinates of the prism 51, assigns timestamps to the results, and transmits the center position coordinates to the measuring module 50 via the surveying-instrument communication unit 25.

### 3. Configuration of Measuring Module 50

The measuring module 50 comprises the prism 51, an electronic distance meter (EDM) 52, an inertial measurement unit (IMU) 53, a storage unit 54, a notification unit 55, an operation unit 56, a display unit 57, a communication unit 58, a clock 59, and a control arithmetic unit 60.

The prism 51 is, for example, a so-called omnidirectional prism, configured by radially combining a plurality of triangular pyramidal prisms to retroreflect light incident from all directions (360°). The prism 51 is not limited thereto and may be any prism used for surveying.

The electronic distance meter 52 includes a light transmitting unit, a distance-measuring optical system, and a light receiving unit, which are not illustrated in FIG. 2. The light transmitting unit, which includes a light emitting element such as a laser diode, emits visible laser light as the distance-measuring light L3. The light receiving unit includes a light receiving element, such as an avalanche photodiode. The electronic distance meter 52 emits the distance-measuring light L3 from the light transmitting unit toward the measurement target and receives reflected distance-measuring light L3′ from the measurement target. The distance to the point irradiated by the distance-measuring light L3 is determined based on the phase difference or the time difference between the distance-measuring light L3 and internal reference light. The electronic distance meter 52 is configured to adjust the output amplitude of the distance-measuring light L3 by controlling the voltage or current applied to the light emitting element.

The inertial measurement unit 53 includes a three-axis gyroscope and a three-axis accelerometer. The inertial measurement unit 53 detects the posture information of the measuring module 50 by measuring the angular velocities and accelerations in three axis directions (roll, pitch, and yaw) of the measuring module 50. The inertial measurement unit 53 is placed at the instrument center O (FIG. 1) of the measuring module 50.

The positional relationship is predetermined among the center of the prism 51, the origin for distance calculation of the electronic distance meter 52, and the instrument center O. The electronic distance meter 52 is configured so that its optical axis passes through the instrument center O. This structure enables the determination of the position coordinates of the measuring module 50 based on the position coordinates of the center of the prism 51 and the posture information of the measuring module 50.

The storage unit 54 is implemented using computer-readable storage media such as hard disk drives (HDDs) or flash memory. The storage unit 54 stores programs that execute functions of the measuring module 50, which will be described later. The storage unit 54 also stores three-dimensional information data, acquired by the measuring module 50.

The notification unit 55 issues warnings, for example, by means of sound, light, or vibration, to alert operators. The notification unit 55 includes a light source that blinks to indicate a status, an audio speaker for playing audio, a buzzer for generating a beep sound, and a vibrator for tactile signaling. The display unit 57 may also serve as the notification unit 55 by displaying notification information on the display screen or blinking the display screen.

The operation unit 56 is an input device that comprises an input mechanism, such as buttons and keys, to receive inputs from the operator, such as commands or configuration settings, and transmit to the measuring module 50. The display unit 57 is implemented with a display such as a liquid crystal display or an organic electroluminescence (EL) display. In the illustrated example, the operation unit 56 and the display unit 57 are integrated as a touch panel display. Furthermore, the operation unit 56 may include an audio input device such as a microphone in addition to buttons and keys. The measurement screen 70 displays various information, such as the measurement path, the position of the measuring module 50, and the position of the irradiated point, superimposed on a measurement region data 72, described later.

The communication unit 58 is a communication interface that facilitates information exchange between the surveying instrument 10 and the measuring module 50. Although examples of communication means include Wi-Fi, Bluetooth (a registered trademark), and infrared communication, any communication means compatible with the surveying-instrument communication unit 25 should be used. The communication unit 58 receives the position coordinates of the prism 51 from the surveying instrument 10.

The clock 59 is a device that keeps time and may be implemented with a system clock or a hardware clock. The clock 59 is synchronized with the surveying-instrument clock 24 of the surveying instrument 10. The clock 59 is used for synchronizing a measurement timing with the surveying instrument 10.

The control arithmetic unit 60 includes at least one processor 61, such as a CPU, and at least one memory 62, such as an SRAM or a DRAM. When the processor 61 carries out a function of the surveying instrument 10 in a software manner, the control arithmetic unit 60 reads programs for implementing functions of the measuring module 50 into the memory 62 and executes the programs to carry out the functions. At least a part of the processor 61 may be configured with hardware such as a CPLD or an FPGA.

The control arithmetic unit 60 enables remote control of the surveying instrument 10 and transmits instructions for measurement and auto-tracking to the surveying instrument 10 via the communication unit 58. The control arithmetic unit 60 acquires a distance to an irradiated point Q measured by the electronic distance meter 52 and the posture information of the measuring module 50 measured by the inertial measurement unit 53, at a timing synchronized with the surveying instrument 10. The control arithmetic unit 60 calculates the position coordinates of instrument center O of the measuring module 50, based on the position coordinates of the prism 51 received from the surveying instrument 10, the posture information of the measuring module 50, and the known positional relationship between the prism 51 and the instrument center O of the measuring module 50. In addition, the control arithmetic unit 60 calculates the position coordinates of the irradiated point Q irradiated by the distance-measuring light L3 based on the calculated position-coordinates of the measuring module 50, the posture information of the measuring module 50, and the measured distance value from the electronic distance meter 52.

### 4. Setting of Partitioned Area

### 4.1 Partitioning of Measurement Range

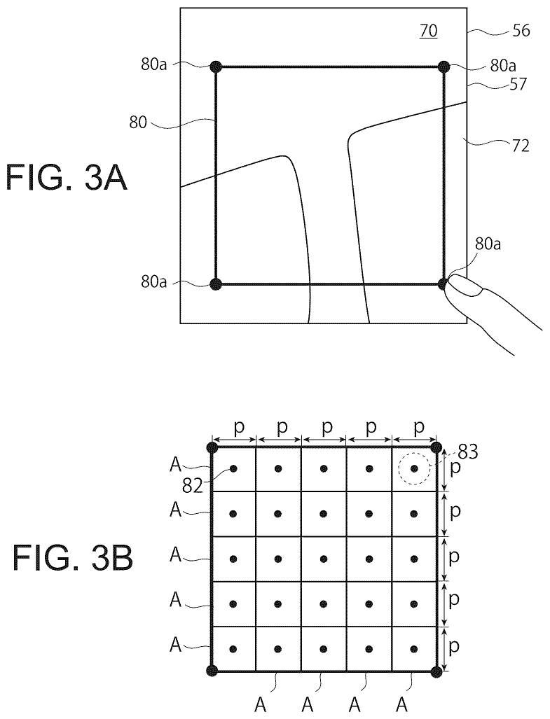

The control arithmetic unit 60 reads the measurement region data 72, sets a measurement range 80 on the data, and partitions the measurement range 80 into partitioned areas. FIG. 3A illustrates how to set the measurement range 80, shown on the display unit 57. The measurement region data 72 is a map data in the illustrated example. The measurement range 80 represents an area where three-dimensional data measurement has been conducted within the measurement region data 72. As illustrated in FIG. 3A, an operator taps points on the display unit 57, which is a touch panel display, to input points as vertexes 80a, and select a rectangular shape to set the measurement range 80. Alternatively, the operator may use a rectangular selection tool and swipe diagonally to draw a rectangle on the display, which sets the measurement range 80. Although the measurement range 80 is set as a square in the illustrated example, the range is not limited thereto. The measurement range 80 may be set as any shape including a rectangle, a polygon, and other shapes. In addition, the measurement range 80 may be set by tracing lines around the desired area using a fingertip.

As illustrated in FIG. 3B, the control arithmetic unit 60 partitions the measurement range 80 into mesh-like partitions with predetermined pitches p in the measurement range 80 of FIG. 3A. The mesh-like partitions are displayed overlaid on the measurement region data, which is shown in FIG. 3A, while the measurement region data 72 is omitted in FIG. 3B for the sake of simplicity. In the illustrated example, the measurement range 80 is a square. Accordingly, the mesh-like partitioned areas (hereinafter, each area referred to as “partitioned area A” unless a specific area is specified) are also squares. The pitch p defines the length of one side of each square; that is, the p determines the dimensions of each partitioned area A. The partitioned areas A are not limited to squares and may be rectangles. In addition, each partitioned area A should be identical in shape in principle; however, at the peripheral edge of the measurement range 80, it may have different shapes depending on the shape of the measurement range 80 because the measurement range may not be evenly partitioned. The pitch p is preferably 10 to 50 cm for the purpose of current surface measurement in construction work. Although not limited to this range, the pitch p may be appropriately determined depending on the size of the measurement range 80 and the required accuracy of the output.

Furthermore, the control arithmetic unit 60 displays the measured area and the unmeasured area in a distinguishable manner on the display unit 57 for each of the partitioned areas A. In addition, the control arithmetic unit 60 displays the measured areas in various colors, in which each color represents a range of measurement values to indicate their scale.

In addition, the control arithmetic unit 60 determines whether the irradiated point Q falls within a predefined distance range, which corresponds to a measurement-scheduled-point range 83 centered on a measurement scheduled point 82. When determining that the irradiated point Q is within the measurement-scheduled-point range 83, the control arithmetic unit 60 initiates measurement and acquires the measurement values as the measurement result.

### 4.2 Re-Partitioning Part of Partitioned Areas

Each time when acquiring the measurement value of the partitioned area A, the control arithmetic unit 60 determines whether the measurement value satisfies a condition, which will be described later. When determining that the measurement value satisfies the condition for the partitioned area A, the control arithmetic unit 60 re-partitions the area A into a plurality of smaller areas with dimensions smaller than initial ones. The measurement value refers to values directly obtained from the measurement and may also include values calculated from them.

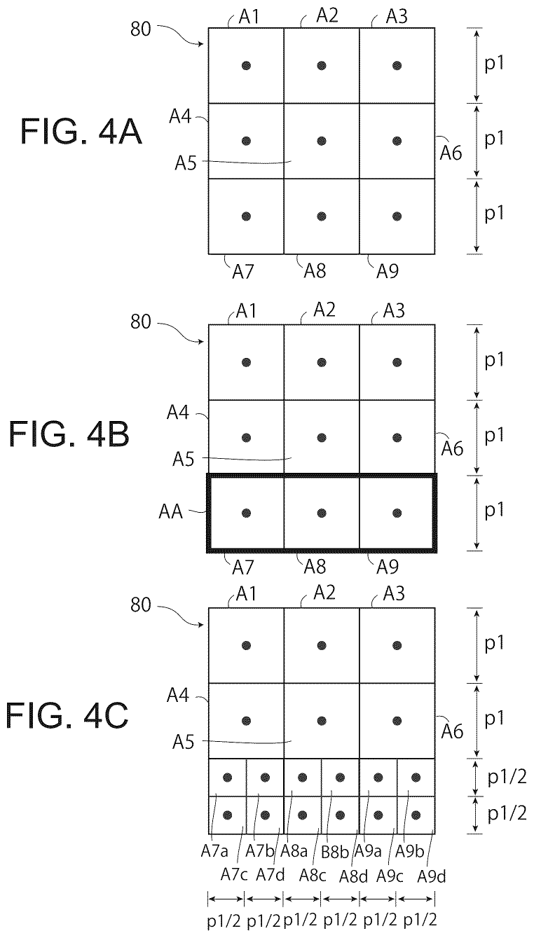

FIG. 4A illustrates the measurement range 80 partitioned by pitch p1. As an example, the measurement range 80 is partitioned into three rows and three columns. Each of the mesh-like partitioned areas is a square with the side length of pitch p1 and referred to as a partitioned area A1, a partitioned area A2, a partitioned area A3, and so on.

The control arithmetic unit 60 re-partitions a part of the measurement range 80 into a plurality of areas smaller than the initially partitioned area when the part satisfies a condition, described later. For example, when the area surrounded by the bold frame in FIG. 4B (the partitioned areas A7, A8, and A9) are an area to be re-partitioned (hereinafter referred to as a “condition-satisfying area AA”, which is indicated by the bold frame), the control arithmetic unit 60 re-partitions the condition-satisfying area AA into areas with a smaller pitch than the initial one. The condition-satisfying area AA, which has been initially partitioned into squares with pitch p1 shown in FIG. 4A, is re-partitioned into squares with the half length of the pitch p1 shown FIG. 4C.

As illustrated in FIG. 4C, the partitioned area A7 is re-partitioned into a partitioned areas A7a, A7b, A7c and A7d. The partitioned areas A1a to A1d are squares with the half-length of p, which is represented as p1/2. Likewise, the partitioned area A8 is re-partitioned into the partitioned areas A8a to A8d, and the partitioned area A9 is re-partitioned into the partitioned areas A9a to A9d. This increases the number of areas in the condition-satisfying area AA to four times that of the initial partitions, resulting in the acquisition of four times the amount of the initial measurement data.

### 4.3 Conditions for Re-Partitioning

The conditions for re-partitioning the condition-satisfying area AA should be defined to ensure more precise measurement. As mentioned above, re-partitioning the condition-satisfying area AA into a plurality of areas with smaller dimensions than the initial ones increases the number of the partitioned areas in the condition-satisfying area AA, thereby increasing the number of measurements. This prevents potential measurement errors, such as decreased accuracy, and allows for the acquisition of more comprehensive and detailed measurement data.

In other words, situations that require the more precise measurement are those when there may have a high probability of errors occurring, and the operator seeks to mitigate the risk by increasing the number of the measurements. Such situations may include: (Condition 1) when the light reception amount of the reflected measuring light L3′ received by the light receiving unit of the electronic distance meter 52 falls outside a threshold range; (Condition 2) when the measurement value of the partitioned area A falls outside a threshold range; and (Condition 3) when the difference between adjacent partitioned areas falls outside a threshold range.

### (Condition 1: Light Amount Outside Threshold Range)

The system 1 is preferably used for current surface measurements at a construction site. The current surface measurement measures the height of points on a surface to assess its unevenness. A surface made of black material absorbs the distance-measuring light L3, decreasing the amount of the reflected distance-measuring light L3,′ thereby decreasing the light reception amount received by the electronic distance meter 52. A surface made of light-diffusing material also decreases the reflected distance-measuring light L3′, thereby decreasing the light reception amount by the electronic distance meter 52. Such a low light reception amount may cause errors. The electronic distance meter 52 acquires the light amount value of the reflected measuring light L3′ during measurement, which is equivalent to the light reception amount.

When the light reception amount by the electronic distance meter 52 falls outside a threshold range, that is, an allowable range, the control arithmetic unit 60 first instructs the notification unit 55 to issue a warning by means of sound, light, or vibration. This allows the operator OP to recognize there might have a decrease in measurement accuracy. Then, the control arithmetic unit 60 re-partitions the measured partitioned area A and its surrounding area into a plurality of areas with dimensions smaller than the initial ones. This re-partitioning resets the measurement values of the partitioned areas A, even if some areas have already been measured. Thus, the operator OP is asked to measure again each of the re-partitioned areas. Making the dimensions of the partitioned area smaller than the initial dimensions increases the number of measurements taken in the condition-satisfying area AA, thereby allowing for more accurate and comprehensive measurement. Likewise, the light reception amount of the reflected distance-measuring light L3′ that exceeds a predetermined value may likely cause errors. Such an increased light reception amount occurs, for example, due to diffused reflection on the measurement surface or light entering from other light sources. The threshold range for the light reception amount may be set with an upper limit as well as a lower limit.

### (Condition 2: Measurement Value Outside Threshold Range)

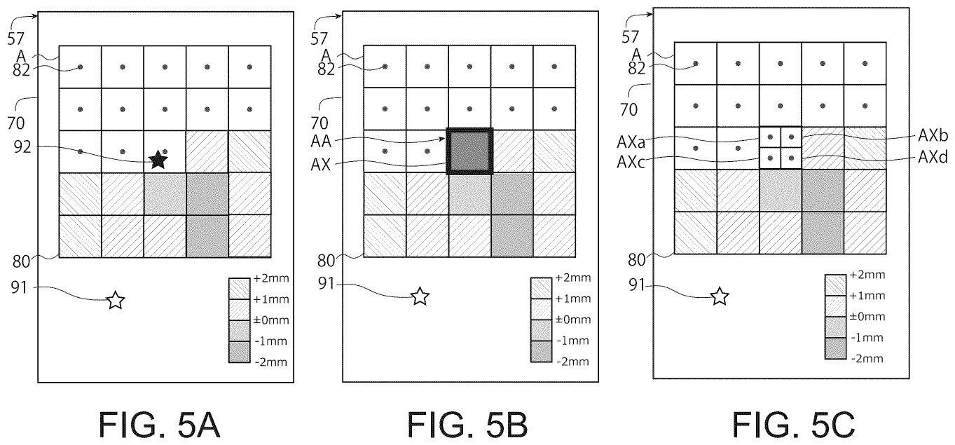

Another condition for re-partitioning the condition-satisfying area AA is when the measurement value falls outside a threshold range. The control arithmetic unit 60 measures the partitioned areas A and stores the measurement values as the measurement result. Determining that the measurement value is out of the threshold range allows the control arithmetic unit 60 to determine there might have a probability of measurement errors occurring or a decrease in measurement accuracy and to initiate re-partitioning of the condition-satisfying area AA into the areas with the smaller dimensions. This will be described with reference to FIGS. 5A to 5C, which illustrate an example of measurement screens 70, displayed on the display unit 57 during measurement.

As illustrated in FIG. 5A, the display unit 57 displays the measurement screen 70 indicating the measurement status during measurement for the current surface measurement at a construction site. The current surface measurement measures the height of points on a surface to assess its unevenness. Displaying the unmeasured partitioned areas A in white and the measured partitioned areas A in colors that vary depending on the height value (Z coordinate value) enables the operator OP to grasp the three-dimensional shape of the measurement range 80.

When the height values that fall within a range of ±3 mm, which are considered as an allowable range of the measurement result, the threshold range is also ±3 mm and a condition is defined as the height values falling outside the threshold range. The control arithmetic unit 60 acquires position coordinates from the measurement result to calculate the height value. When the height value is outside the threshold range, the control arithmetic unit 60 determines that the condition is satisfied and identifies the corresponding partitioned area as the condition-satisfying area AA for re-partitioning. The control arithmetic unit 60 then re-partitions the condition-satisfying area AA into a plurality of area with smaller dimensions.

FIG. 5B illustrates, as an example, the case where the partitioned area AX has a height value exceeding +3 mm, indicating that the partitioned area AX is set as the condition-satisfying area AA for re-partitioning. The control arithmetic unit 60 determines the height value is outside of the threshold range and instructs the notification unit 55 to notify the operator OP. Further, as illustrated in FIG. 5C, the control arithmetic unit 60 re-partitions the partitioned area AX into areas with pitches smaller than the pitches of the initial partitioning. The partitioned area AX, which has been partitioned into squares, is re-partitioned into squares again, but with half the side length of the initial one. Thus, the partitioned area AX is re-partitioned into the partitioned areas Axa, AXb, AXc, and AXd, each having a square shape with a half-length of the initial side. Along with the re-partitioning, the control arithmetic unit 60 resets the measurement result for the partitioned area AX and changes the colors of the partitioned area AX into white on the measurement screen 70, indicating that the partitioned areas Axa to AXd are unmeasured.

Partitioning the partitioned area AX into four partitioned areas AXa to AXd leads to the acquisition of four times the amount of the measurement data, resulting in the acquisition of more detailed measurement in the condition-satisfying area AA. This prevents measurement errors and a decrease of measurement accuracy to enable more accurate and comprehensive measurement.

### (Condition 3: Difference Between Adjacent-Area Measurement Values Outside Threshold Range)

Still another condition for re-partitioning the condition-satisfying area AA is when the difference between the calculated measurement values (three-dimensional data) for adjacent partitioned areas falls outside a threshold range. The control arithmetic unit 60 measures the partitioned areas A and stores the measurement values as the measurement result. The control arithmetic unit 60 calculates the difference between the measurement results of the adjacent areas each time when acquiring the measurement result. When the measurement result is outside of the threshold range, the control arithmetic unit 60 determines that there might have a probability of measurement errors occurring or a decrease in measurement accuracy and initiates re-partitioning of the condition-satisfying area AA into areas with smaller dimensions.

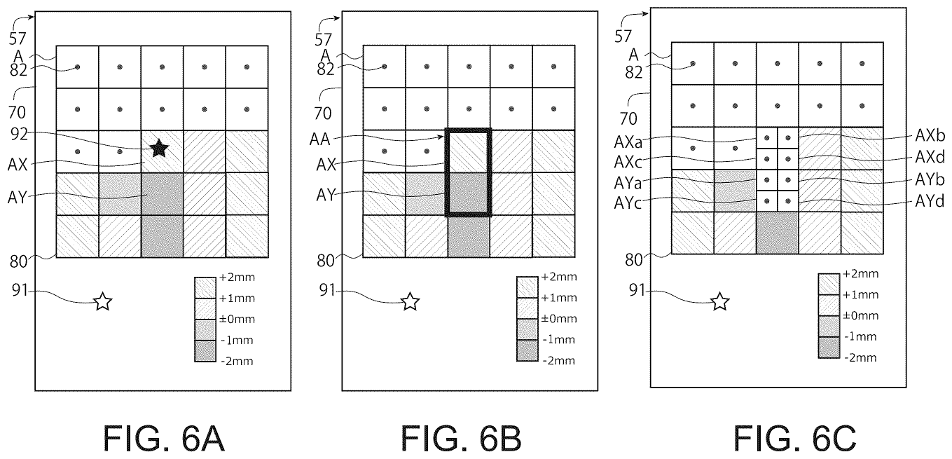

This case will be described with reference to FIGS. 6A to 6C. FIGS. 6A to 6C, likewise FIGS. 5A to 5C, illustrate the measurement screen 70 for the current surface measurement at a construction site.

As illustrated in FIG. 6A, the display unit 57 displays the measurement status on the measurement screen 70 during measurement. Displaying the unmeasured partitioned area A in white and the measured partitioned area A in colors that vary depending on the height value (Z coordinate value) enables the operator OP to grasp the three-dimensional shape of the measurement range 80.

The acquisition of the measurement results for a partitioned area A causes the display unit 57 to change the color in the partitioned area A from white to a color depending on the height value, on the measurement screen 70. The control arithmetic unit 60 calculates the difference between the measurement values of partitioned area A and another partitioned area A adjacent thereto and determines whether the difference falls outside a predetermined threshold range.

Assuming that the threshold range for the difference in measurement values (height values) between adjacent areas is the same range as the allowable range of the measurement results, the threshold is ±3 mm and a condition is defined as the height value falling outside the threshold range. The control arithmetic unit 60 calculates the height-value difference between the adjacent partitioned areas A. When the height-value difference is outside of the threshold range, the control arithmetic unit 60 determines that the condition is satisfied and identifies the corresponding partitioned area A as the condition-satisfying area AA for re-partitioning. The control arithmetic unit 60 re-partitions the partitioned areas A into a plurality of areas with smaller dimensions.

As illustrated in FIG. 6B, when the measurement result shows that the height value for the partitioned area AX is +2 mm, and the height value of the partitioned area AY, which is adjacent to the partitioned area AX, is −2 mm, the height difference between the partitioned areas AX and AY is 4 mm, which exceeds the threshold.

Determining that the height difference between the adjacent partitioned areas A is outside of the threshold range, the control arithmetic unit 60 instructs the notification unit 55 to issue a warning. As illustrated in FIG. 6C, the control arithmetic unit 60 re-partitions the partitioned areas AX and AY as the condition-satisfying area AA into areas with dimensions smaller than the initial ones. The partitioned areas AX and AY, which have been initially partitioned into squares, are partitioned into four squares each with half the side length of the initial one. Thus, the partitioned area AX is re-partitioned into the partitioned areas AXa to AXd, which are squares with the half the side length of the partitioned area AX. Similar to the partitioned area AX, the partitioned area AY is re-partitioned into the partitioned areas AYa to AYd, which are squares with the half the side length of the initial one.

After re-partitioning the condition-satisfying area AA, the control arithmetic unit 60 resets the measurement value of the partitioned areas AX and AY corresponding to the condition-satisfying area AA. Then, the control arithmetic unit 60 sets the partitioned area AX as the unmeasured partitioned areas AXa to AXd and the partitioned area AY as the unmeasured partitioned areas AYa to AYd, and changes the colors of the unmeasured partitioned areas AXa to AXd and AYa to AYd on the measurement screen 70 into white, indicating that the areas are unmeasured.

The number of the partitioned areas AX and AY becomes four times, resulting in the acquisition of four times the amount of measurement data, compared to the initial ones. This allows the acquisition of more detailed measurement data in the condition-satisfying area AA, thereby preventing measurement errors and a decrease of measurement accuracy to enable more accurate and comprehensive measurement.

### (Light Intensity Control of Electronic Distance Meter)

The electronic distance meter 52 emits visible laser light as the distance-measuring light. The light emitting element that emits the laser light is configured to adjust the light intensity by controlling the voltage or current applied to the light emitting element. Thus, an output amplitude of the distance-measuring light L3 is adjustable. Increasing the output amplitude enhances the light amount of the distance-measuring light L3 and the light intensity of the reflected distance-measuring light L3′, which can lead to the improvement of the reliability in measurement.

The aim of the re-partitioning of the initially partitioned area into smaller areas in the measurement range 80 is to increase the number of measurements to prevent measurement errors and a decrease in the measurement accuracy. For this purpose, the output amplitude of the electronic distance meter 52 may be increased in response to the re-partitioning of the condition-satisfying area AA into a plurality of smaller areas. This can improve the reliability of the re-measurement.

The control arithmetic unit 60 recursively determines the threshold ranges of the measurement value and calculates the difference value between the adjacent, re-partitioned areas. When the measurement value falls outside the threshold range in the re-partitioned smaller areas, the re-partitioned areas will be re-measured with higher output amplitude of the distance-measuring light L3. This re-measuring also contributes to increase the reliability of the measurement results.

### 5. Three-Dimensional Data Measurement

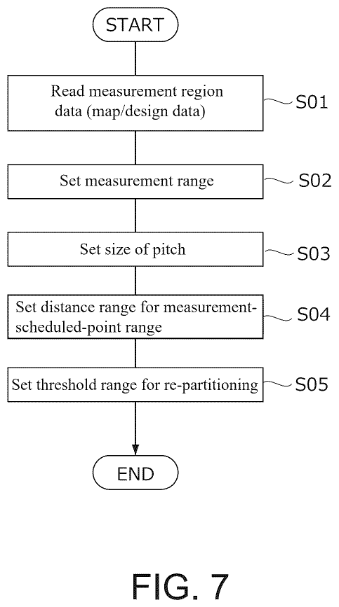

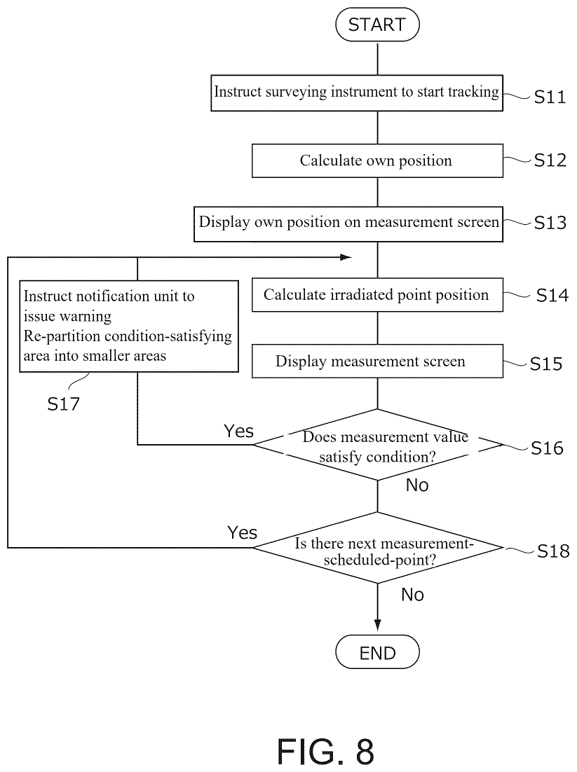

Next, a three-dimensional data measurement method using the system 1 will be described. FIGS. 7 and 8 are flowcharts illustrating examples of the three-dimensional data measurement method using the system 1. FIG. 7 illustrates a pre-process of the three-dimensional data measurement, and FIG. 8 illustrates a main process thereof.

First, as a preliminary preparation for use on site, the surveying instrument 10 is installed at a known point, and the operator OP inputs the coordinates and direction angles of the surveying instrument into the surveying instrument 10.

Second, the operator establishes a connection between the communication unit 58 of the measuring module 50 and the communication unit 25 of the surveying instrument 10, then calibrates the measuring module 50. For calibration, for example, the operator OP align face to face of the surveying instrument 10 and the measuring module 50, and measure the prism 51 with the surveying instruments to determine the direction of the measuring module 50. The operator OP uses the direction information to set the inertial measurement unit 53 with the roll, yaw and pitch angles thereof are zero degrees from the opposite direction of the measuring module 50.

### (Pre-Process Flow Chart)

The pre-process of the three-dimensional data measurement will be described with reference to FIG. 7.

After starting the measurement, in Step S01, the control arithmetic unit 60 reads the measurement region data 72. The measurement region data 72 is, particularly, map data or design data of the site that the operator OP is scheduled to measure. The measurement region data 72 may be Computer-Aided Design (CAD) data. The control arithmetic unit 60 may read the measurement region data 72 stored in advance in the storage unit. Alternatively, the control arithmetic unit 60 may read the measurement region data 72 stored in a cloud server or other online storages as the measuring module 50 may include a communication interface connectable via the Internet to the online storages and have stored the measurement region data 72 in advance.

Next, in step S02, the control arithmetic unit 60 sets the measurement range 80 in accordance with the operator's input. For example, the operator can set the measurement range 80 by tapping four vertexes on the measurement region data 72 on the display unit 57, which is configured with a touch panel.

Next, in step S03, the control arithmetic unit 60 sets the size of the pitch p, which defines the dimensions of meshes to partition the measurement range 80 into mesh-like partitioned areas in accordance with the operator's input through the operation unit 56. The value of the pitch p can be set by using an input method from the operator, for example, selecting a value from the predetermined values, or inputting a value in an input field.

Next, in step S04, the control arithmetic unit 60 sets a distance range that defines the measurement-scheduled-point range 83 in accordance with the operator's input. The distance range for the measurement-scheduled-point range 83 may be already set in advance. In this case, step S04 can be omitted. When the partitioned area is re-partitioned into smaller areas, the distance range for the measurement scheduled point range 83 becomes smaller accordingly.

Next, in step S05, the control arithmetic unit 60 sets threshold values used for determination to re-partition the partitioned area A. The thresholds may be set by direct input as a numerical value or automatic determination depending on the type of measurement. Or, the thresholds may be set by selection from levels in which the thresholds are set in stages from a strict value to a lenient value. Further, the control arithmetic unit 60 sets the pitch for re-partitioning of the condition-satisfying area AA. The pitch can be set by selecting from the predetermined numerical values, such as ½ or ⅓ of the set pitch p, or directly inputting numerical values in an input field

### (Main Process Flow Chart)

Next, the main process of three-dimensional data measurement will be described with reference to FIG. 8.

In step 11, the control arithmetic unit 60 instructs the surveying instrument 10 to start tracking via the communication unit 58. Then, the surveying instrument 10 tracks the prism 51 and measures the prism 51 at predetermined intervals to transmit the position coordinates of the prism 51 with the timestamp to the measuring module 50.

Next, in step S12, the control arithmetic unit 60 detects the posture information of the measuring module 50 at a timing synchronized with the measurement of the position coordinates of the prism 51 to calculate the position coordinates of the instrument center O of the measuring module.

Next, in step S13, the control arithmetic unit 60 displays the measurement screen 70 on the display unit 57 to display an own position mark 91 at the position coordinates of the instrument center O on the measurement screen 70 (see FIGS. 5 and 6).

After this, the control arithmetic unit 60 repeats steps S11 to S13. The control arithmetic unit 60 calculates the position coordinates of the instrument center O of the measuring module 50 when receiving the position coordinates of the prism 51 or at a predetermined timing. Upon calculating the position coordinated of the prim 51, the control arithmetic unit 60 updates the measurement screen 70 including the own position mark 91 on the display unit 57.

Then, in step S14, when the electronic distance meter 52 emits the distance-measuring light L3 to detect a distance to the irradiated point Q, by an instruction from the operator OP or the control by the control arithmetic unit 60, the control arithmetic unit 60 calculates the position coordinates of the irradiated point Q by using the posture information of the measuring module 50.

Then, in step S15, the control arithmetic unit 60 stores the measurement result and displays the position of the irradiated point Q, which is shown with an irradiation mark 92 in FIGS. 5A and 6A. The control arithmetic unit 60 also calculates the height value based on the calculated position coordinates of the irradiated point Q and displays the partitioned area A in colors that vary depending on the height value.

In step S16, the control arithmetic unit 60 determines whether the measurement value satisfies a condition. The condition includes whether the measurement value falls outside the allowable range. In particular, the control arithmetic unit 60 determines whether the light reception amount of the reflected distance-measuring light L3′ falls outside the threshold range, whether the height value calculated from the acquired position coordinates of the irradiated point Q falls outside the threshold range, or whether the calculated height difference between the adjacent partitioned areas A falls outside the threshold range. The control arithmetic unit 60 may determine at least one condition: either a single condition or any two of the three conditions, or all three conditions. Then, determining at least one condition being satisfied (a YES line of S16), the control arithmetic unit 60 determines the measurement value is outside the allowable range, shifting to step 17. In other cases (a NO line of S16), that is, determining any conditions not being satisfied, the control arithmetic unit 60 determines the measurement value is within the allowable range, shifting to step 18.

In step S17, the control arithmetic unit 60 instructs the notification unit 55 to issue a warning. The control arithmetic unit 60 re-partitions the condition-satisfying area AA that is outside the threshold range into smaller areas, and cancels the measurement value of the condition-satisfying area AA to display the condition-satisfying area AA as an unmeasured area on the measurement screen 70 of the display unit 57. At this time, the electronic distance meter 52 may have a higher light intensity setting. Then process returns to step S14.

Then, the control arithmetic unit 60 continues repeating steps S14 to S18 until receiving instruction to end in step S18.

### 6. Technical Effects

As described above, the present embodiment comprises the measuring module 50 which includes the prism 51, the electronic distance meter 52, and the inertial measurement unit 53, and can acquire the position coordinates of the prism 51. This allows the acquiring the irradiated point coordinates of the distance measurement light with the measuring module 50 in any postures the operator moves, thereby enabling the three-dimensional data measurement without using a pole with a prism. Furthermore, the system 1 measures the position of the measuring module 50 with the surveying instrument 10, not with a GNSS device. This ensures that the measurement accuracy indoors is comparable to that outdoors. In addition, this structure eliminates the need to consider the number or the geometric arrangement of the satellites.

Moreover, in the measuring module 50, the measurement screen 70 displayed on the display unit 57 is configured to distinguish the measured area and the unmeasured area. This allows the operator OP to proceed with the measurement while checking the progress of the work. Furthermore, displaying the measured area in colors that vary depending on the height value allows the operator OP to grasp the three-dimensional shape of the measurement range in the real-time manner. This also allows the operator OP to distinguish the partitioned areas A to re-measure at a glance, after the partitioned areas A is re-partitioned.

The measuring module 50 uses visible light for the distance-measuring light L3. This configuration allows the operator OP to move the measuring module 50 while observing the irradiated point Q of the distance-measuring light L3 on the actual object, thereby improving work efficiency.

The system 1 re-partitions the initially partitioned area A into a plurality of smaller areas according to the conditions during the measurement of the partitioned area A. The conditions are used to detect a probability of measurement errors or a decrease in measurement accuracy. Upon detecting such a probability of the measurement errors or the decrease in the measurement accuracy, the system 1 re-partitions a single partitioned area into a plurality of smaller areas, thereby increasing the number of measurements in the re-measurement. The re-measurements address the measurement errors or the decrease in measurement accuracy and can improve the reliability of the measurement.

The operator OP measures the measurement range 80 with gripping the measuring module 50 to irradiate the measurement range 80 by the distance-measuring light, and checks the measurement results in real time on the measurement screen 70. When the control arithmetic unit 60 acquires the measurement value, it determines the decrease of the measurement accuracy. If the control arithmetic unit 60 detects the possibility of the decrease in the measurement accuracy, the control arithmetic unit 60 causes the notification unit 55 to issue a warning. The operator OP can sense the probability of the measurement-accuracy decrease immediately and thus re-measure the condition-satisfying area in detail. This enables higher accurate and more comprehensive acquisition of the three-dimensional data for the measurement range 80.

In the present embodiment, the measurement value falling outside threshold range leads to re-partitioning the partitioned area into smaller areas. Not limited to this, when the measurement values remain within the threshold range continuously and the measurement values do not fluctuate much, the partitioned areas may be re-partitioned into areas with larger dimensions. This helps to save labor in the measurement work. In this case, it is preferable to set the threshold range smaller and more stringent.

Although the preferred embodiments of the present invention have been described above, the above-described embodiments are examples of the present invention. These embodiments can be combined based on knowledge of those skilled in the art, and such forms are also included in the scope of the present invention.

### REFERENCE SIGNS LIST

1: Three-dimensional data measuring system
10: Surveying instrument
50: Measuring module
51: Prism
52: Electronic distance meter
53: Inertial measurement unit
55: Notification unit
57: Display unit
58: Communication unit
60: Control arithmetic unit
70: Measurement screen
80: Measurement range
A: Partitioned area
AA: Condition-satisfying area
L3: Distance-measuring light
L3′: Reflected distance-measuring light
Q: Irradiated point

1. A three-dimensional data measuring system comprising:
a measuring module including
a prism retroreflecting incident light,
an electronic distance meter configured to transmit distance-measuring light to a measurement range, receive a reflected distance-measuring light reflected from an irradiated point of the distance-measuring light, to detect a distance to the irradiated point,
an inertial measurement unit detecting posture information,
a notification unit configured to issue a warning,
a communication unit configured to receive prism position coordinates, and
a control arithmetic unit configured to calculate position coordinates of the measuring module based on the prism position coordinates and the posture information, and calculate irradiated point position coordinates based on the position coordinates of the measuring module, the distance to the irradiated point, and the posture information; and
a surveying instrument configured to measure a distance to and angle of the prism to acquire the prism position coordinates, and transmit the prism position coordinates to the communication unit,
the system configured to acquire three-dimensional data of the measurement range, wherein
the control arithmetic unit is configured to
partition the measurement range into mesh-like partitioned areas and acquire three-dimensional data for each partitioned area, and
determine whether the partitioned area satisfies at least one condition each time acquiring a measurement value for the partitioned area, and, when the partitioned area satisfies the condition, instruct the notification unit to issue a warning and re-partition a condition-satisfying area that satisfies the condition into a plurality of areas with dimensions smaller than initial dimensions.

2. The three-dimensional data measuring system according to claim 1, wherein
the at least one condition includes that adjacent partitioned areas have a difference in the three-dimensional data outside a threshold range.

3. The three-dimensional data measuring system according to claim 1, wherein
the at least one condition includes that the electronic distance meter receives the reflected measuring light at a light reception amount outside a threshold range.

4. The three-dimensional data measuring system according to claim 1, wherein
The at least one condition includes that the partitioned area have the three-dimensional data outside a threshold range.

5. The three-dimensional data measuring system according to claim 1, further comprising a display unit configured to display a measurement screen indicating a measurement status of the measurement range, wherein
the display unit displays a measurement progress for each partitioned area in a manner allowing real-time identification,
the measurement screen displays the partitioned area that has been measured in colors that vary depending on a measurement result for the partitioned areas, and
after re-partitioning the condition-satisfying areas, the control arithmetic unit resets the measurement value of the condition-satisfying area, so that the display unit displays the condition-satisfying area in a color indicating that the re-partitioned condition satisfying area are unmeasured.
